(19) United States
(12) Patent Application Publication
(10) Pub. No.: US 2004/0230541 A1
(43) Pub. Date: Nov. 18, 2004

(54) Process for estimating and reducing cost of cycling

(76) Inventors: Steven A. Lefton, Palo Alto, CA (US); Philip M. Besuner, Los Altos, CA (US)

Correspondence Address: Thomas B. Haverstock, HAVERSTOCK & OWENS LLP, 162 North Wolfe Road, Sunnyvale, CA, 94086, US

(21) Appl. No.: 10/439,733

(22) Filed: May 16, 2003

(51) Int. Cl. G06F 17/60

(52) U.S. Cl. 705/400

(57) ABSTRACT

The present invention is a method, system and apparatus of estimating the cost of cycling in power plant operation. The present invention is integrated in to the power plant data acquisition and control systems (DACS), and computes damage accumulation rates and dollar costs for specific types of power plant operation including cycling operation. The present invention collects real-time measurements from the power plant DACS and calculates actual damage and ultimately cost accumulation present in the power plant.

### FIELD OF THE INVENTION

The present invention relates generally to the field of industrial operation cost estimation. More particularly, the present invention relates to the field of estimating and reducing the cost of cycling in power plant operation.

### BACKGROUND OF THE INVENTION

In today's volatile electricity markets, most power plants must be flexible; often load following to specified minimum loads (and below), and frequently cycling on/off. This type of cycling operation can be very damaging to power plants, and add large costs due to increased equipment wear and tear, and adverse heat rate effects. For some large generation units, these costs can amount to millions of dollars per year. These costs can be greatly reduced by proper operation tuning and operator training.

In recent years, power plant operators have been concerned that generation unit cost, and in particular, the wear-and-tear aspects of cycling costs, have not been well understood and estimated. Many fossil units have been cycled much more extensively than what they were originally designed for due to changes in overall system load and resource constraints. This has led to higher forced outage rates, increased maintenance costs, and larger capital replacement costs for these units, prompting power plant operators to spend resources in order to reduce system costs. To reduce system costs, power plant operators must tune the plant cycling operations via improved cycling procedures and improved system dispatch and operations planning. What is needed is a fast response, real-time method to improve system dispatch and operations planning.

There are a number of system dispatch models in use by electric utility dispatchers. These models were developed with the objective of determining optimum hourly dispatch schedules with unit fuel costs, heat rates, and operational constraints, the primary factors in determining the optimal schedules. More recently, with the increases in market interchanges and complex purchase and sales contracts, significant effort has been put into better modeling of energy and capacity transactions. One area that has not been seriously looked at by most utility dispatchers and unit commitment vendors is the damage or wear-and-tear rates caused by varying generation unit operation practices, including on-off cycling, load following cycling, load changes with varying Mega Watt (MW) ramp rates, load following at varying load depths, higher than rated capacity operation, and minimum load operation. The design of the current system dispatch models does not include capabilities of modeling these damage rate factors other than allowing for “startup costs,” for which the utility often plugs in only startup fuel and auxiliary power, thereby neglecting any wear and tear damage costs from cycling.

Inclusion of damage costs for all the various operational options listed above in the current system dispatch models would be a different task and would undoubtedly require hundreds of thousands of dollars and more than one year of time. This type of resource commitment would be needed for each unit system dispatch model being used, thus the costs are not easily shared among power plant operators. What is needed generally is a program that reduces cycling costs, monitors damage accumulation rates, improves control of load transients, optimizes day ahead plant operation and helps train new operators on cycling operations. What is also needed is a new type of dispatch program which includes all the “damage as a function of operations” factors listed above, to be considered with the other major fuel, heat, rate, operational constraints, and transactions factors.

### SUMMARY OF THE INVENTION

The present invention is a method, system and apparatus of estimating the cost of cycling in power plant operation. The present invention is integrated in to the power plant data acquisition and control systems (DACS), and computes damage accumulation rates and dollar costs for specific types of power plant operation including cycling operation. The present invention collects real-time measurements from the power plant DACS and calculates resultant damage and ultimately cost accumulation present in the power plant.

In one aspect of the present invention, a method of estimating a real-time cost of cycling in a power plant using a set of historical data and real-time pressure, flow rate and temperature data comprises calibrating using the set of historical data, receiving a set of real-time operating parameters from the power plant, receiving a set of real-time plant data from the power plant and calculating a set of real-time output data from the set of real-time operating parameters and the set of real-time plant data, wherein the set of real-time output data includes real-time monetary costs of load transients. The set of real-time operating parameters is a set of megawatt data. Calibrating with the set of historical data includes gathering the set of historical data, reviewing a set of signature data from the historical data to develop a critical equipment list, defining a group of critical cycling components, developing a cycling damage report for the group of critical cycling components, performing an assessment and operation review, interviewing a group of plant personnel, developing a plant damage model, performing statistical regression analysis and selecting operational improvement measures. Calculating the set of real-time output data includes converting the set of real-time megawatt data in a loads mode to a set of real-time damage calculations, combining the set of real-time plant data and a set of expected plant data ramp rates, comparing the combined set of real-time plant data and the set of expected plant data ramp rates to the set of real-time damage calculations to produce a set of real-time modified damage calculations and manipulating the set of real-time modified damage calculations with a cost algorithm.

The set of plant data is a unit load and a set of key temperature points, the set of key temperature points comprises a superheater temperature point, a reheater temperature point, a boiler temperature point and a turbine temperature point. The set of expected plant data ramp rates is a set of expected transients measured during megawatt load changes. The loads model compares the set of real-time megawatt data to an expected megawatt load change and a set of rate of change data for each of the group including hot starts, warm starts, cold starts and load follows. The method further comprises collecting the set of real-time megawatt data and the set of real-time plant data from the power plant with a plurality of sensors, wherein the plurality of sensors are configured such that the set of real-time megawatt data and the set of real-time plant data are received from the plurality of sensors. The method further comprises displaying the set of real-time output data on a graphical user interface and warning a user when any of the set of real-time operating parameters, the set of real-time plant data and the set of real-time output data exceeds predetermined limits.

In another aspect of the present invention, a system for estimating a real-time cost of cycling in a power plant using a set of historical data and real-time pressure, flow rate and temperature data comprises means for calibrating using the set of historical data, means for receiving a set of operating parameters from the power plant, means for receiving a set of real-time plant data from the power plant and means for calculating a set of real-time output data from the set of real-time operating parameters and the set of real-time plant data, wherein the set of real-time output data includes real-time monetary costs of load transients. The set of real-time operating parameters is a set of real-time megawatt data. The means for calibrating with the set of historical data includes means for gathering the set of historical data, means for reviewing a set of signature data from the historical data to develop a critical equipment list, means for defining a group of critical cycling components, means for developing a cycling damage report for the group of critical cycling components, means for performing an assessment and operation review, means for interviewing a group of plant personnel, means for developing a plant damage model, means for performing statistical regression analysis and means for selecting operational improvement measures. The means for calculating the set of real-time output data includes, means for converting the set of real-time megawatt data in a loads mode to a set of real-time damage calculations, means for combining the set of real-time plant data and a set of expected plant data ramp rates, means for comparing the combined set of real-time plant data and the set of expected plant data ramp rates to the set of real-time damage calculations to produce a set of real-time modified damage calculations and means for manipulating the set of real-time modified damage calculations with a cost algorithm.

The set of plant data is a unit load and a set of key temperature points, the set of key temperature points comprises a superheater temperature point, a reheater temperature point, a boiler temperature point and a turbine temperature point. The set of expected plant data ramp rates is a set of expected transients measured during megawatt load changes. The loads model compares the set of real-time megawatt data to an expected megawatt load change and a set of rate of change data for each of the group including hot starts, warm starts, cold starts and load follows. The system further comprises means for collecting the set of real-time megawatt data and the set of real-time plant data from the power plant with a plurality of sensors, wherein the plurality of sensors are configured such that the set of real-time megawatt data and the set of real-time plant data are received from the plurality of sensors. The system further comprises means for displaying the set of real-time output data on a graphical user interface and means for warning a user when any of the set of real-time operating parameters, the set of real-time plant data and the set of real-time output data exceeds predetermined limits.

In yet another aspect of the present invention, an article of manufacture comprises a computer readable medium bearing program code embodied therein for use with a computer, the computer program code includes means for calibrating with a set of historical data such that the computer program code is configured to estimate a real-time cost of cycling for a power plant, means for receiving a set of real-time operating parameters from the power plant, means for receiving a set of real-time plant data from the power plant and means for calculating a set of real-time output data from the set of real-time operating parameters and the set of real-time plant data, wherein the set of real-time output data includes real-time monetary costs of load transients. The set of real-time operating parameters is a set of real-time megawatt data. The means for calibrating with the set of historical data includes means for gathering the set of historical data, means for reviewing a set of signature data from the historical data to develop a critical equipment list, means for defining a group of critical cycling components, means for developing a cycling damage report for the group of critical cycling components, means for performing an assessment and operation review, means for interviewing a group of plant personnel, means for developing a plant damage model, means for performing statistical regression analysis and means for selecting operational improvement measures. The means for calculating the set of real-time output data includes means for converting the set of real-time megawatt data in a loads mode to a set of real-time damage calculations, means for combining the set of real-time plant data and a set of expected plant data ramp rates, means for comparing the combined set of real-time plant data and the set of expected plant data ramp rates to the set of real-time damage calculations to produce a set of real-time modified damage calculations and means for manipulating the set of real-time modified damage calculations with a cost algorithm.

The set of plant data is a unit load and a set of key temperature points, the set of key temperature points comprises a superheater temperature point, a reheater temperature point, a boiler temperature point and a turbine temperature point. The set of expected plant data ramp rates is a set of expected transients measured during megawatt load changes. The loads model compares the set of real-time megawatt data to an expected megawatt load change and a set of rate of change data for each of the group including hot starts, warm starts, cold starts and load follows. The article of manufacture further comprises means for collecting the set of real-time megawatt data and the set of real-time plant data from the power plant with a plurality of sensors, wherein the plurality of sensors are configured such that the set of real-time megawatt data and the set of real-time plant data are received from the plurality of sensors. The article of manufacture further comprises means for displaying the set of real-time output data on a graphical user interface and means for warning a user when any of the set of real-time operating parameters, the set of real-time plant data and the set of real-time output data exceeds predetermined limits.

In yet another aspect of the present invention, an apparatus for estimating a real-time cost of cycling in a power plant using a set of historical data and real-time pressure, flow rate and temperature data, wherein the apparatus is calibrated with the set of historical data such that the apparatus is configured to estimate the cost of cycling for the power plant, the apparatus comprises a storage media for storing a computer application, a processing unit coupled to the storage media and a user interface coupled to the processing unit such that a user can receive a set of real-time operating parameters from the power plant, receive a set of real-time plant data from the power plant and calculate a set of real-time output data from the set of real-time operating parameters and the set of real-time plant data, wherein the set of real-time output data includes real-time monetary costs of load transients. The set of real-time operating parameters is a set of real-time megawatt data. The apparatus warns a user when any of the set of real-time operating parameters, the set of real-time plant data and the set of real-time output data exceeds predetermined limits.

### BRIEF DESCRIPTION OF THE DRAWINGS

FIG. 1 is a graphical representation of a typical utility lifetime equivalent forced outage rate.

FIG. 2 is a graphical representation of typical creep-fatigue interaction curves.

FIG. 3 is a graphical representation illustrating a method of the preferred embodiment of the present invention.

FIG. 4 is a schematic representation illustrating a method of the preferred embodiment of the present invention.

FIG. 5 is a graphical representation illustrating the architecture of the preferred embodiment of the present invention.

FIG. 6 is a graphical user interface of the preferred embodiment of the present invention.

### DETAILED DESCRIPTION OF THE PREFERRED EMBODIMENT

The method, system and apparatus of the present invention strives to improve the system dispatch and operations planning in utilities by creating a dispatch program that includes damage or wear-and-tear rates caused by varying generation unit operation practices, to be used in conjunction with the other major fuel, heat rate, operational constraints, and transactions factors to estimate the total cost of cycling of a utility power plant while generating megawatt load.

Creep and Fatigue Damage

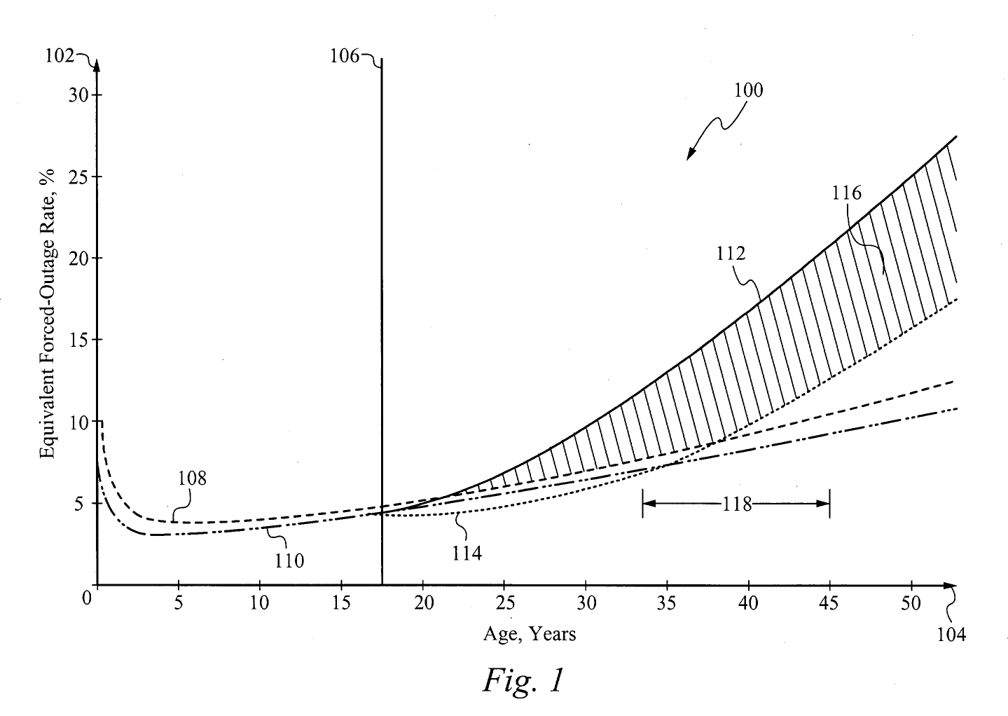

FIG. 1 depicts a graphical representation of a utility lifetime equivalent forced outage rate comparison 100. The x-axis 104 represents the age in years of the plant and the y-axis 102 represents the equivalent forced-outage rate in percentage. This comparison 100 is intended to illustrate how a plant not configured for cycling has increased maintenance costs, reduced generation and shorter life spans. The comparison 100 is typical for a 600MW fossil-fueled unit and this plant size is exemplary only to show how plants unequipped for cycling can lose life time and efficiency.

Plants designed for cycling 108 and those upgraded for cycling 114 at the time cycling begins 106 have a performance line that gently slopes and, in the case of the upgraded for cycling 114 plant, reaches an equivalent forced-outage rate shown here as no higher than 15% over a fifty (50) year life span. Plants not designed for cycling and not upgraded for cycling 112 when cycling begins 106 show a rapid increase in equivalent forced-outage rate relative to the plants designed for cycling 108 and those upgraded for cycling 114 when cycling begins 106. The equivalent forced-outage rates for the plants not upgraded for cycling 112 in a plant such as the one shown in FIG. 1 may have an equivalent forced-outage rate of 25 percent or higher over the same 50 year life span.

Still referring to FIG. 1, the above described difference in equivalent forced-outrage rates in the plant not upgraded for cycling 112 and the plant upgraded for cycling 114 illustrates the lost generation 116 that occurs when a plant is not upgraded for cycling 112. Such a severe increase in equivalent forced-outage rate (EFOR) in the plant not upgraded for cycling 112 reaches a 10% EFOR much earlier and thus results in a plant life reduction 118.

A better understanding of the cycling process is needed to understand better the present invention. Cycling refers to the operation of electric generating units at varying load levels, including on/off and low load variations, in response to changes in system load requirements. Every time a power plant is turned off and on, the boiler, steam lines, turbine, and auxiliary components go through unavoidably large thermal and pressure stresses, which cause damage. This damage is made worse by the phenomenon called creep-fatigue interaction.

Creep and fatigue are terms commonly used in engineering mechanics. Creep is time-dependent change in the size or shape of a material due to constant stress (or force) on that material. In fossil power plants, creep is caused by continuous stress that results from constant high temperature and pressure in a pipe or tube occurring during steady-state baseload operation. Fatigue is a phenomenon leading to fracture (failure) when a material is under repeated, fluctuating stresses. In a fossil power plant, such fluctuating stresses result from large transients in both pressures and temperatures. These transients typically occur during cyclic operation.

Because baseload fossil units are designed to operate in the creep range, they experience increased outages when they are additionally subjected to a cycling-related fatigue. The term creep-fatigue interaction suggests that the two phenomena (creep and fatigue) are not necessarily independent, but act in a synergistic manner to cause premature failure. In fact, materials behave in a complex manner when both types of stresses occur. Creep-fatigue interaction is one of the most important phenomena contributing to component failures and can have a detrimental effect on the performance of metal parts or components operating at elevated temperatures. It has been found that creep strains (i.e., mechanical deformation as a result of stress) can reduce fatigue life and that fatigue strains can reduce creep life.

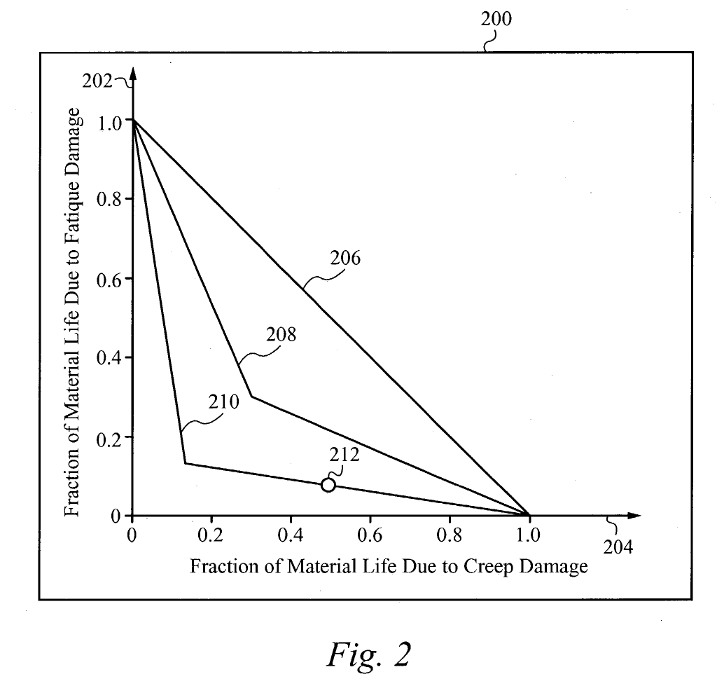

FIG. 2 illustrates creep-fatigue interaction curves 200. These interaction curves 200 reveal how creep-fatigue interaction affects the life expectancies (i.e., time to failure) of three type of materials. The x-axis 204 illustrates a material's fraction of material life due to creep damage, while the y-axis 202 illustrates the fraction of material life due to fatigue damage. Most power plants have been built using ferritic steels, such as 1¼Cr-1 Mo steel, which is shown here as curve 210. Note the nonlinear relationship of this curve. A brand new power plant component can withstand a lot of fatigue damage before it fails. However, a material that has gone through 50% of life creep damage (e.g., baseload operation), as shown by point 212, reaches end of life with only about 10% fatigue damage. Older units that were designed and used for baseload operation over a number of years are very susceptible to component failure when they are forced to cycle on a regular basis. In general, this type of material that experiences both creep and fatigue will fail much faster than if it experiences creep alone. The more linear curve 208 and curve 206 illustrate the characteristics of “304 & 316 type Stainless Steels” and “Ni—Fe—Cr 800H,” respectively.

Relating FIG. 2 to power plants, if an older, baseloaded plant (that previously experienced three to six starts per year and is at 40% to 80% design life creep damage) is now dispatched to operate at 50 starts per year, it may take only 2 to 6 years to accumulate 10% to 20% total fatigue damage needed to cause component failures. Thus, while cycling-related increases in failure rates may not be noted immediately, critical components will eventually start to fail. Shorter component life expectancies will result in higher plant EFOR and/or higher capital and maintenance costs to replace components at or near the end of their service lives. In addition, cycling may result in reduced overall plant life. How soon these detrimental effects will occur will depend on the amount of creep damage present and the specific types and frequency of the cycling.

Cost of Cycling Solution

The present invention includes a method, system and apparatus for estimating the cost of cycling is based on a number of factors. In the preferred embodiment of the present invention, calibrating must occur before the damage and cost estimations are made. The steps to calibrate will be described below. First, data must be gathered pertinent to past and present operation of the plant. The type of data that will be utilized includes, but is not limited to unit operations, plant or unit maintenance and capital cost data, unit test data, plant design data, economic analysis factors and total temperature changes and temperature rates during online generation operational transients of hot starts, warm starts, cold starts, trips, normal shutdowns and low load megawatt operation. Ideally, these data should cover most of the unit history; if not, the data must be estimated from less specific sources using publically available (EPA) and private data bases (at Aptech, Nere, etc.)

After this data is gathered, a review of the plant signature data must be made. In the preferred embodiment of the present invention, this review includes developing a critical equipment list with the components currently know to cause major outages and costs such as the boiler and turbine. The past outage data will be analyzed to define the critical cycling-related components. For these critical components, the temperature data will be utilized to develop cycling damage by type of cycling (e.g. hot start, warm, start, cold start, load cycle, etc.)

After the data is reviewed, an assessment and operation review must be made. This includes investigating and assessing the major causes of failures at the selected plant, and determining whether they are wholly or partially caused by cycling or low load operation. This assessment and review includes reviewing tube failure records and other cycling related major failure modes such as boiler, turbine, generator, fans, pumps, feedwater heater and condenser equipment and discussing them with plant personnel, reviewing the cycling related failures with other plants that have been studied and reviewing plant operational procedures to improve operation and maintenance procedures for cycling operations.

The calibration continues in the preferred embodiment of the present invention as selected plant personnel are interviewed in order to utilize opinions of at least six key plant personnel to foresee what effects different modes will have on the plant equipment. Preferably, the interviewees should include a representative from the following departments: plant management, operations, general maintenance, turbine maintenance, boiler maintenance and plant chemistry. A damage model for the plant and unit damage histories will be developed using preferably 3 to 20 years of past hourly data and minute by minute MW data from preferably one to six typical months. The damage model calculates total unit baseload and cyclic damage, and calculates damage under cyclic and steady loads of any magnitude that interact with each other in a nonlinear fashion. The damage model accounts for any combination of operational loads including load peaks and valleys, times at load, ramp rates (load changes with time), and differences among hot, warm and cold starts. Thus it handles all types of cycling in combination with normal, derated, or uprated steady loads.

The calibration also includes statistical regression (with nonlinear equations and constraints) of damage rates in terms of certain annual and “candidate” cycling costs versus damage in units of equivalent hot starts (EHS). The candidate costs exclude fixed labor costs, and other expenses judged to have no relationship to how the unit is operated. The regression results to develop best estimates and upper and lower bounds of the largest cycling cost components, capital and maintenance costs and outage costs, and to develop cycling cost estimates for what are typically the largest cycling cost components—namely, increased capital and maintenance spending, increased outages leading to more expensive replacement power, and increased heat rates due to low and variable load operation. The calibration finally includes evaluating and selecting operational and chemistry improvement measures that will reduce cycling related damage rates and costs. The final draft and report of this information will be used for the calibration step in the preferred embodiment of the present invention.

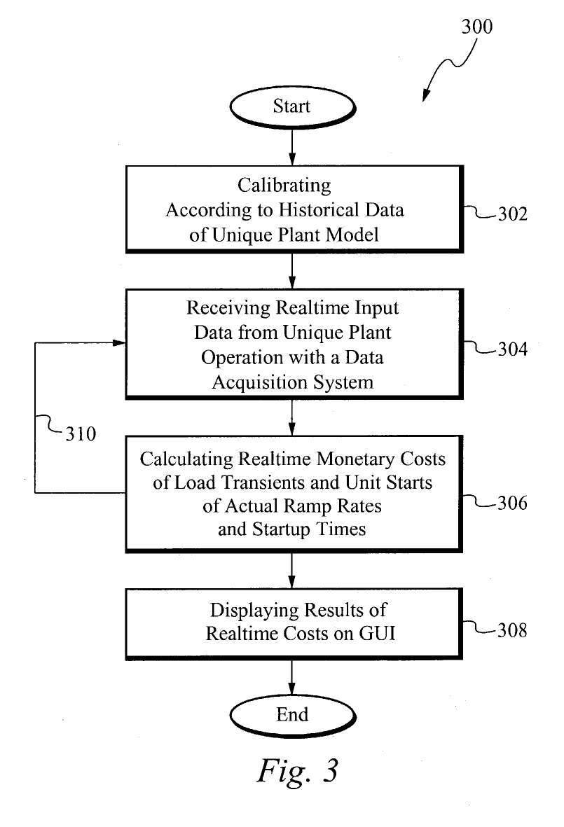

FIG. 3 depicts a method of the preferred embodiment of the present invention. In step 302, calibrating the historical data occurs as is described in the above detailed description. As is also described above, the method is calibrated in step 302 according to unique plant data provided by the plant operators. After the calibrating in step 302, real-time input data is received from the unique plant while in operation in step 304. The real-time input is received by a data acquisition system in step 304 utilizing sensors on the turbine, the boiler and in the balance of the plant. Preferably, 15 to 20 existing sensors are utilized to receive this real-time information. However, more or less sensors may be utilized as needed or desired. Likewise, additional sensors may be installed as needed or desired in lieu of utilizing existing sensors.

Still referring to FIG. 3, the method of the preferred embodiment of the present invention then calculates real-time monetary costs of load transients and unit starts to determine the cost of actual ramp rates and startup times in step 306. The calculating step in step 306 utilizes the real-time input data received in step 304 and an algorithm which will be described in greater detail below. After the calculating step in 306, the method displays the results of the costs of cycling on a graphical user interface (GUI) in step 308. It should be noted that the path 310 in FIG. 3 indicates that the method will continue as long as real-time input data is received in step 304, thereby available for calculating and display in steps 306 and 308, respectively. In other words, as additional real-time input data is received in step 304, the method continuously calculates in step 306 and displays the results on the GUI in step 308. The absence of input data being received in step 304 will result in the last set of results calculated in step 306 being displayed on the GUI in step 308.

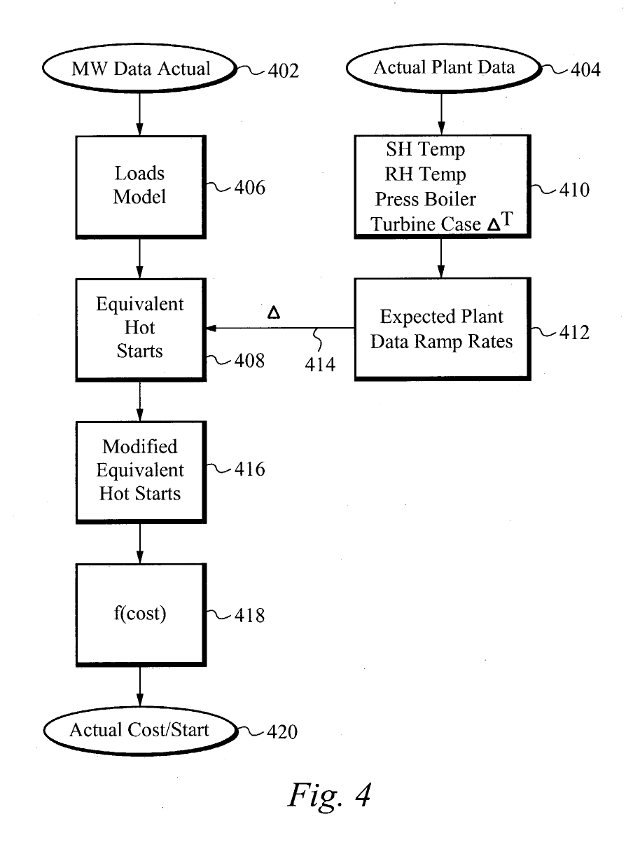

FIG. 4 depicts a schematic illustration of the method of the preferred embodiment of the present invention. Specifically, FIG. 4 provides a more detailed schematic account of steps 304, 306 and 310. FIG. 4 depicts the calculation of damage from real-time plant monitoring data consisting of key boiler and turbine temperatures, pressures, flow rates, and other relevant readings (Actual Plant Data 404) and megawatt load level (MW Data Actual 402). The actual plant data 404 preferably consists of unit load and up to twenty critical temperature measurement and other reading points chosen to reflect damage accumulation in key unit components and that have been shown to be good indicators of plant-wide damage and costs. These key temperatures 410 include but are not limited to superheater (SH Temp), reheater (RH Temp), boiler (Press Boiler) as evidenced by the drum temperature, and the turbine (Turbine Case Δ T) as evidenced by a valve, shell, or chest differential temperature or turbine stress.

Still referring to FIG. 4, expected plant data ramp rates 412 (temperature) are calculated and compared with typical or expected values at each plant. The key temperatures 410 and the ramp rate data 412 are combined with the MW data actual 402 after the MW data actual is processed by the loads model 406. The loads model 406 quantifies load transients and the resulting damage in terms of an idealized load cycle known as an equivalent hot start (EHS); our preferred units for expressing cycling damage 408. The method uses EHS 408 as a reference to which the current load transient is compared, with the monetary damage result displayed graphically for the interested operators. Therefore, referring to FIG. 3 and FIG. 4, the real-time input data received in step 304 is actually split into two groups (MW data actual 402 and actual plant data 404) and schematically take separate paths to becoming modified EHS 414. Then, a cost algorithm 418 converts the modified EHS 408 to actual money in terms of startup damage costs 420.

Referring again to FIG. 4, in the first path the MW data actual 402 is passed to the loads model 406 for comparison to typical expected megawatt load changes and rate of change data during any hot start, warm start, cold start or load follow. This MW data actual 402 is then converted to EHS 408, based on the damage each operation incurs compared to a hot start. In the second path the actual plant data 404 in the form of the key temperatures 410 are compared to expected transients that have been previously measured during well-controlled actual megawatt load changes. The expected plant data ramp rates 412 and the key temperatures 410 are compared to expected transient values and any outliers eliminated. The results of this comparison shown by path 414 increases or decreases the EHS 408 derived from the MW data actual 402. Thus, megawatt load changes that are performed when the key temperatures 410 are at controlled acceptable levels and pressure transients have less damage, and thus, less costs than rapid load changes accompanied by less controlled pressure and temperature transients of key components.

Still referring to FIG. 4, these two components produce the modified EHS 416, which is manipulated by the cost algorithm 418 to calculate the startup damage costs 420 for any start or load change or sustained loading. This cost algorithm 418 can be updated and modified based on new cost data and projected future cost or budget. The GUI displays 308 (FIG. 3) the actual plant's megawatt load changes or any proposed load cycle and the resultant corresponding monetary damage costs of both load changes.

In the preferred embodiment of the present invention, the cost algorithm 418 of FIG. 4 includes a number of cost elements. The first cost element is the additional maintenance, operational, overhaul and capital costs that are attributed to cycling. These are typically the long term wear and tear costs associated with additional maintenance and additional overhauls required on cycling units. Experience in the industry shows that maintenance and capital spending typically increases, and overhaul and repair times lengthen, with increased power plant cycling. This cost element includes the capital cost of cycling related improvements. These improvements would include turbine bypass systems, stress analyzers, and equipment to upgrade automatic operation, such as automatic burner insertion, burner management systems, controls upgrades, chemistry upgrades and turbine water-induction protection.

The second cost element is the forced outage recovery cost. Forced outages and equivalent derations are typically more frequent and of longer duration in cycling units than in baseload units. The recovery costs for additional forced outages should include some of the outages due to operator error. Such errors have included boiler explosions, boiler implosions, generator out-of-phase synchronization, generator motoring, water-induction damage, miscellaneous operator valving errors, miscellaneous errors involving humans, and automatic equipment and control system failures. Increase cycling obviously results in increased opportunities for error. The second cost element also includes the cost of having to increase utilization of less economical generation units (or purchase power) due to lower availability of the cycled units. The second cost element also includes system long term generation capacity costs. These costs include the need for short term purchase of replacement capacity due to higher plant outages.

The third cost element includes increased unit heat rates in the longer term due to component degradation, such as worn seals. The fourth cost element is the dynamic effects of variable load and “load following” on actual unit fuel bum and heat rates. This element includes the poor heat rate experienced from synchronization at “0” megawatts to the unit's minimum load. The invention uses in-service fuel burn data to estimate the heat rate effects; and relies on idealized test heat rate data only as a reference. The fifth cost element is typically a smaller component and includes fuel, electrical power, and chemicals needed for unit startup. The sixth cost element includes the costs of unit life shortening and acceleration of the need for cost expenditures to build new capacity due to shortened life of the units being cycled.

The seventh cost element, general engineering and management cost, includes the cost of cycling studies, general engineering study costs associated with modifications and upgrades to plants to make them cycle better, management costs associated with optimizing the units to cycle more efficiently, and increased costs to properly dispatch the unit in cycling. Determining the optimal dispatch strategy is a very complex optimization procedure and the cost of developing an appropriate dispatch algorithm for use in system operation should be accounted for. The seventh element includes efforts to understand and compensate for the tradeoffs among the other six cost elements, such as the optimal maintenance expenditure to forestall outages.

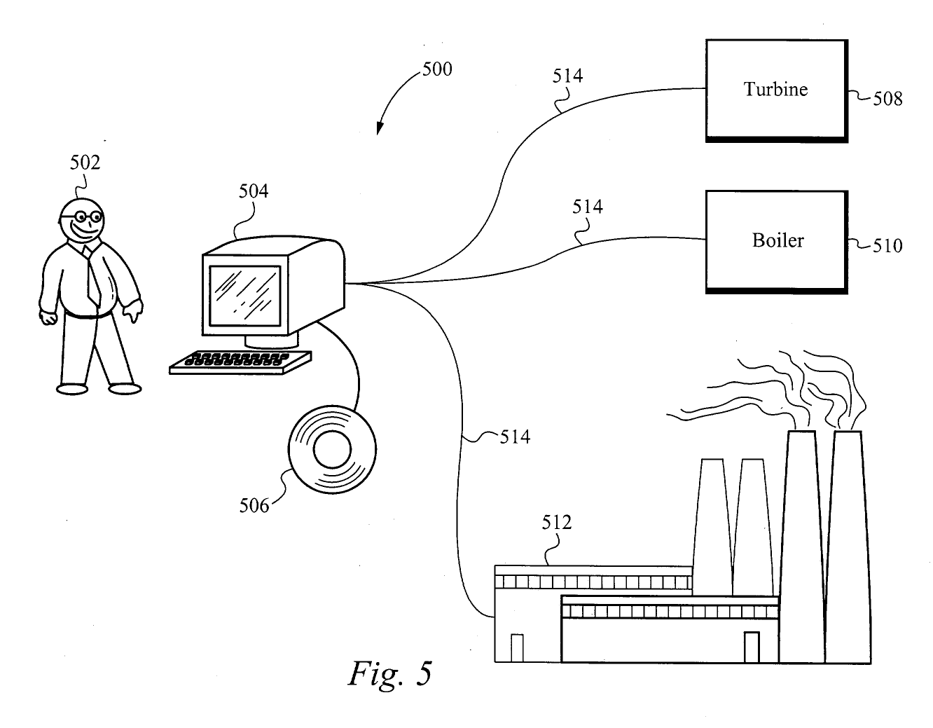

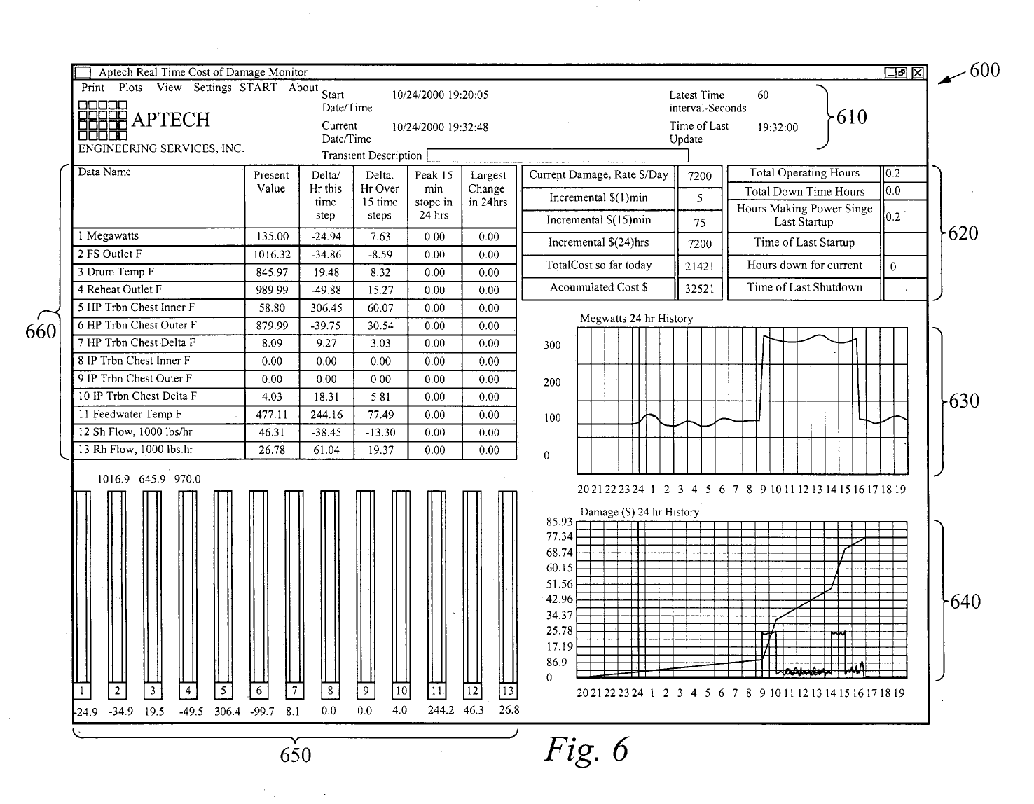

FIG. 5 depicts a system 500 of the preferred embodiment of the present invention. A user 502 such as a plant manager, operator, or other plant official utilizes a personal computer (PC) 504 having a storage medium 506. Preferably, software able to execute the method of the present invention is loaded into the storage medium 506 for use on the PC 504. Preferably the PC 504 runs the Windows® operating system. However, the PC 504 may also run under other operating systems such as MS DOS®. Preferably, the software used to execute the method of the present invention uses Excel®, OSI Pi® and Visual Basic® macros and programs compiled from FORTRAN code to plot and chart the actual megawatt data and any desired megawatt load changes that are entered into the Excel® files or similar input files. All of these software applications and operating systems are preferably located in the storage medium 506. Preferably, the PC 504 includes a GUI, the GUI is configured such that the software operation and the results of the method of the preferred embodiment of the present invention are displayed on the GUI. The plant damage display screens show the corresponding monetary cost of either the actual or any proposed load cycle. A load cycle is defined as the complete on/off cycle or load change and a return to the starting load. A GUI of the preferred embodiment of the present invention will be discussed in more detail in FIG. 6.

Still referring to FIG. 5, the PC 504 is coupled to a number of sensors 514. Typically, power plants have a number of sensors built into the plant to monitor temperature and pressure in the turbine, boilers and other parts of the plant. The number of these pre-existing sensors usually numbers in the dozens or even hundreds. Preferably, the PC 504 or the preferred embodiment of the present invention is coupled to 15 to 20 pre-existing sensors 514. However, more or less sensors 514 may be utilized as needed according to the unique parameters of each power plant monitored. Referring back to FIG. 5, the preferred 15 to 20 sensors 514 are split among three main areas: the turbines 508, the boilers 510 and the balance of the plant 512. Preferably, the 15 to 20 sensors 514 are divided equally or near equally between these three groups. Again, unequal division of the sensors 514 may be implemented as needed. The sensors 514 collect the appropriate data as described in the method above and transmit that data back to the PC 504 so that the software stored in the storage medium 506 can process that data according to the method described above and provide output results on the GUI.

FIG. 6 depicts a GUI 600 of the preferred embodiment of the present invention. The current status 610 of the estimation method is displayed on the top portion of the GUI and the current monetary status 620 is displayed below the current status 610. The GUI 600 of the preferred embodiment of the present invention also includes a MW history graph 630 as well as a damage history graph 640. Each sensor 514 (FIG. 5) utilized in the preferred embodiment will have a corresponding sensor reading 650 in the GUI as well as a sensor output 660, displayed as numerical data. Alternative embodiments may be utilized that shift the display areas outlined in the preferred embodiment throughout the display area of the GUI. Furthermore, alternative embodiments may include more or less input and output data displays and more or less displays in general. Allowable and dangerous values are specified for all key sensor inputs. The user is warned when sensor readings leave their specified ranges.

Conclusion

The preferred embodiment of the present invention is unique in its ability to include equipment damage rates for all types and characteristics of power plant operations including cycling and MW operation levels in developing optimal system dispatch schedules. This tends to lower plant damage and total combined fuel and damage costs while meeting system loads. Preferably, the present invention aids one to find the lowest system cost hourly dispatch schedule taking into account all major cost factors, including generation equipment wear and tear.

The cost algorithm of the preferred embodiment of the present invention also includes the heat rate impact model developed for each unit in the utility's system, which includes the standard heat rate impact of changed load levels, as well as the complex dynamic heat rate effects caused by inefficiencies due to changing load levels. This model is calibrated for each unit using monthly (or shorter interval) fuel burn and operations data over several years of past operation. The preferred embodiment also has the capability of accounting for energy transactions of varying types. However, we must fully understand the various transaction contracts and market price structures currently in effect at utilities in order for them to be properly modeled in the cost algorithm. Thus detailed modeling of its energy and capacity transaction opportunities is typically part of the proposal to develop and apply a system specific model.

The preferred embodiment of the present invention is being used to provide guidance on cycling strategies as input to real-time dispatch programs. In other words, it is used on a daily or weekly basis to provide guidance on optimal dispatch schedules, including wear and tear costs. The actual interface between the present invention and the real-time dispatch program may be detailed ramp and load level constraints that would minimize total system costs over the dispatch period, thus saving millions of dollars in overall costs.

The present invention has been described in terms of specific embodiments incorporating details to facilitate the understanding of the principles of construction and operation of the invention. Such reference herein to specific embodiments and details thereof is not intended to limit the scope of the claims appended hereto. It will be apparent to those skilled in the art that modifications can be made in the embodiment chosen for illustration without departing from the spirit and scope of the invention.

What is claimed is:

1. A method of estimating a real-time cost of cycling in a power plant using a set of historical data and real-time pressure, flow rate and temperature data, the method of estimating the real-time cost of cycling comprising:
a. calibrating using the set of historical data;
b. receiving a set of real-time operating parameters from the power plant;
c. receiving a set of real-time plant data from the power plant; and
d. calculating a set of real-time output data from the set of real-time operating parameters and the set of real-time plant data, wherein the set of real-time output data includes real-time monetary costs of load transients.

2. The method as claimed in claim 1 wherein the set of real-time operating parameters is a set of megawatt data.

3. The method as claimed in claim 2 wherein calibrating with the set of historical data includes:
a. gathering the set of historical data;
b. reviewing a set of signature data from the historical data to develop a critical equipment list;
c. defining a group of critical cycling components;
d. developing a cycling damage report for the group of critical cycling components;
e. performing an assessment and operation review;
f. interviewing a group of plant personnel;
g. developing a plant damage model;
h. performing statistical regression analysis; and
j. selecting operational improvement measures.

4. The method as claimed in claim 2 wherein calculating the set of real-time output data includes:
a. converting the set of real-time megawatt data in a loads mode to a set of real-time damage calculations;
b. combining the set of real-time plant data and a set of expected plant data ramp rates;
c. comparing the combined set of real-time plant data and the set of expected plant data ramp rates to the set of real-time damage calculations to produce a set of real-time modified damage calculations; and
d. manipulating the set of real-time modified damage calculations with a cost algorithm.

5. The method as claimed in claim 4 wherein the set of plant data is a unit load and a set of key temperature points, the set of key temperature points comprising:
a. a superheater temperature point;
b. a reheater temperature point;
c. a boiler temperature point; and
d. a turbine temperature point.

6. The method as claimed in claim 4 wherein the set of expected plant data ramp rates is a set of expected transients measured during megawatt load changes.

7. The method as claimed in claim 4 wherein the loads model compares the set of real-time megawatt data to an expected megawatt load change and a set of rate of change data for each of the group including hot starts, warm starts, cold starts and load follows.

8. The method as claimed in claim 2 further comprising collecting the set of real-time megawatt data and the set of real-time plant data from the power plant with a plurality of sensors, wherein the plurality of sensors are configured such that the set of real-time megawatt data and the set of real-time plant data are received from the plurality of sensors.

9. The method as claimed in claim 2 further comprising displaying the set of real-time output data on a graphical user interface.

10. The method as claimed in claim 2 further comprising warning a user when any of the set of real-time operating parameters, the set of real-time plant data and the set of real-time output data exceeds predetermined limits.

11. A system for estimating a real-time cost of cycling in a power plant using a set of historical data and real-time pressure, flow rate and temperature data, the system for estimating the real-time cost of cycling comprising:
a. means for calibrating using the set of historical data;
b. means for receiving a set of operating parameters from the power plant;
c. means for receiving a set of real-time plant data from the power plant; and
d. means for calculating a set of real-time output data from the set of real-time operating parameters and the set of real-time plant data, wherein the set of real-time output data includes real-time monetary costs of load transients.

12. The system as claimed in claims 11 wherein the set of real-time operating parameters is a set of real-time megawatt data.

13. The system as claimed in claim 12 wherein the means for calibrating with the set of historical data includes:
a. means for gathering the set of historical data;
b. means for reviewing a set of signature data from the historical data to develop a critical equipment list;
c. means for defining a group of critical cycling components;
d. means for developing a cycling damage report for the group of critical cycling components;
e. means for performing an assessment and operation review;
f. means for interviewing a group of plant personnel;
g. means for developing a plant damage model;
h. means for performing statistical regression analysis; and
j. means for selecting operational improvement measures.

14. The system as claimed in claim 12 wherein the means for calculating the set of real-time output data includes:
a. means for converting the set of real-time megawatt data in a loads mode to a set of real-time damage calculations;
b. means for combining the set of real-time plant data and a set of expected plant data ramp rates;
c. means for comparing the combined set of real-time plant data and the set of expected plant data ramp rates to the set of real-time damage calculations to produce a set of real-time modified damage calculations; and
d. means for manipulating the set of real-time modified damage calculations with a cost algorithm.

15. The system as claimed in claim 14 wherein the set of plant data is a unit load and a set of key temperature points, the set of key temperature points comprising:
a. a superheater temperature point;
b. a reheater temperature point;
c. a boiler temperature point; and
d. a turbine temperature point.

16. The system as claimed in claim 14 wherein the set of expected plant data ramp rates is a set of expected transients measured during megawatt load changes.

17. The system as claimed in claim 14 wherein the loads model compares the set of real-time megawatt data to an expected megawatt load change and a set of rate of change data for each of the group including hot starts, warm starts, cold starts and load follows.

18. The system as claimed in claim 12 further comprising means for collecting the set of real-time megawatt data and the set of real-time plant data from the power plant with a plurality of sensors, wherein the plurality of sensors are configured such that the set of real-time megawatt data and the set of real-time plant data are received from the plurality of sensors.

19. The system as claimed in claim 12 further comprising means for displaying the set of real-time output data on a graphical user interface.

20. The system as claimed in claim 12 further comprising means for warning a user when any of the set of real-time operating parameters, the set of real-time plant data and the set of real-time output data exceeds predetermined limits.

21. An article of manufacture comprising a computer readable medium bearing program code embodied therein for use with a computer, the computer program code including:
a. means for calibrating with a set of historical data such that the computer program code is configured to estimate a real-time cost of cycling for a power plant;
b. means for receiving a set of real-time operating parameters from the power plant;
c. means for receiving a set of real-time plant data from the power plant; and
d. means for calculating a set of real-time output data from the set of real-time operating parameters and the set of real-time plant data, wherein the set of real-time output data includes real-time monetary costs of load transients.

22. The article of manufacture as claimed in claim 21 wherein the set of real-time operating parameters is a set of real-time megawatt data.

23. The article of manufacture as claimed in claim 22 wherein the means for calibrating with the set of historical data includes:
a. means for gathering the set of historical data;
b. means for reviewing a set of signature data from the historical data to develop a critical equipment list;
c. means for defining a group of critical cycling components;
d. means for developing a cycling damage report for the group of critical cycling components;
e. means for performing an assessment and operation review;
f. means for interviewing a group of plant personnel;
g. means for developing a plant damage model;
h. means for performing statistical regression analysis; and
j. means for selecting operational improvement measures.

24. The article of manufacture as claimed in claim 22 wherein the means for calculating the set of real-time output data includes:
a. means for converting the set of real-time megawatt data in a loads mode to a set of real-time damage calculations;
b. means for combining the set of real-time plant data and a set of expected plant data ramp rates;
c. means for comparing the combined set of real-time plant data and the set of expected plant data ramp rates to the set of real-time damage calculations to produce a set of real-time modified damage calculations; and
d. means for manipulating the set of real-time modified damage calculations with a cost algorithm.

25. The article of manufacture as claimed in claim 24 wherein the set of plant data is a unit load and a set of key temperature points, the set of key temperature points comprising:
a. a superheater temperature point;
b. a reheater temperature point;
c. a boiler temperature point; and
d. a turbine temperature point.

26. The article of manufacture as claimed in claim 24 wherein the set of expected plant data ramp rates is a set of expected transients measured during megawatt load changes.

27. The article of manufacture as claimed in claim 24 wherein the loads model compares the set of real-time megawatt data to an expected megawatt load change and a set of rate of change data for each of the group including hot starts, warm starts, cold starts and load follows.

28. The article of manufacture as claimed in claim 22 further comprising means for collecting the set of real-time megawatt data and the set of real-time plant data from the power plant with a plurality of sensors, wherein the plurality of sensors are configured such that the set of real-time megawatt data and the set of real-time plant data are received from the plurality of sensors.

29. The article of manufacture as claimed in claim 22 further comprising means for displaying the set of real-time output data on a graphical user interface.

30. The article of manufacture as claimed in claim 22 further comprising means for warning a user when any of the set of real-time operating parameters, the set of real-time plant data and the set of real-time output data exceeds predetermined limits.

31. A method of estimating a real-time cost of cycling in a power plant using a set of historical data and real-time pressure, flow rate and temperature data, the method of estimating the real-time cost of cycling comprising:
a. calibrating with the set of historical data;
b. collecting a set of real-time operating parameters and a set of real-time plant data from the power plant with a plurality of sensors;
c. calculating a set of real-time output data from the set of real-time operating parameters and the set of real-time plant data, wherein the set of real-time output data includes real-time monetary costs of load transients, the calculating step including:
i. converting the set of real-time operational parameters in a loads mode to a set of real-time damage calculations;
ii. combining the set of real-time plant data and a set of expected plant data ramp rates;
iii. comparing the combined set of real-time plant data and the set of expected plant data ramp rates to the set of real-time damage calculations to produce a set of real-time modified damage calculations; and
iv. manipulating the set of real-time modified damage calculations with a cost algorithm; and
d. displaying the set of real-time output data on a graphical user interface.

32. The method as claimed in claim 31 wherein the set of real-time operating parameters is a set of real-time megawatt data.

33. The method as claimed in claim 32 wherein calibrating with the set of historical data includes:
a. gathering the set of historical data;
b. reviewing a set of signature data from the historical data to develop a critical equipment list;
c. defining a group of critical cycling components;
d. developing a cycling damage report for the group of critical cycling components;
e. performing an assessment and operation review;
f. interviewing a group of plant personnel;
g. developing a plant damage model;
h. performing statistical regression analysis; and
j. selecting operational improvement measures.

34. The method as claimed in claim 32 wherein the set of real-time plant data is a unit load and a set of key temperature points, the set of key temperature points comprising:
a. a superheater temperature point;
b. a reheater temperature point;
c. a boiler temperature point; and
d. a turbine temperature point.

35. The method as claimed in claim 32 wherein the set of expected plant data ramp rates is a set of expected transients measured during megawatt load changes.

36. The method as claimed in claim 32 wherein the loads model compares the set of real-time megawatt data to an expected megawatt load change and a set of rate of change data for each of the group including hot starts, warm starts, cold starts and load follows.

37. The method as claimed in claim 32 further comprising warning a user when any of the set of real-time operating parameters, the set of real-time plant data and the set of real-time output data exceeds predetermined limits.

38. An apparatus for estimating a real-time cost of cycling in a power plant using a set of historical data and real-time pressure, flow rate and temperature data, wherein the apparatus is calibrated with the set of historical data such that the apparatus is configured to estimate the cost of cycling for the power plant, the apparatus comprising:
a. a storage media for storing a computer application;
b. a processing unit coupled to the storage media; and
c. a user interface coupled to the processing unit such that a user can receive a set of real-time operating parameters from the power plant, receive a set of real-time plant data from the power plant and calculate a set of real-time output data from the set of real-time operating parameters and the set of real-time plant data, wherein the set of real-time output data includes real-time monetary costs of load transients.

39. The apparatus as claimed in claim 38 wherein the set of real-time operating parameters is a set of real-time megawatt data.

40. The apparatus as claimed in claim 39 wherein a user is warned when any of the set of real-time operating parameters, the set of real-time plant data and the set of real-time output data exceeds predetermined limits.
